(19) United States
(12) Patent Application Publication
(10) Pub. No.: US 2026/0279614 A1
(43) Pub. Date: Sep. 17, 2026

(54) Atomic Object Confinement Apparatus with Damascene Surface Electrodes

(71) Applicant: Quantinuum LLC, Broomfield, CO (US)

(72) Inventors: Daniel Gerald OUELLETTE, Minneapolis, MN (US); Susan Eileen SHORE, Golden Valley, MN (US); Matthew BLAIN, Broomfield, CO (US); Adam Jay OLLANIK, Boulder, CO (US); Rezlind BUSHATI, Rockville, MD (US); Todd Michael KLEIN, Wayzata, MN (US); Christopher T. ERTSGAARD, Champlin, MN (US)

(21) Appl. No.: 19/051,797

(22) Filed: Feb. 12, 2025

Related U.S. Application Data
(60) Provisional application No. 63/562,324, filed on Mar. 7, 2024.

(51) Int. Cl. G21K 1/20

(52) U.S. Cl. CPC G21K 1/20

(57) ABSTRACT

An atomic object confinement apparatus includes a substrate comprising a plurality of metal routing features; a plurality of electrodes disposed on a surface of the substrate and in electric communication with respective metal routing features of the plurality of metal routing features; and a plurality of gaps. Respective gaps of the plurality of gaps disposed between adjacent electrodes of the plurality of electrodes. Respective exposed surfaces of the plurality of electrodes have root mean square (RMS) roughness of 10 nm or less.

### CROSS-REFERENCE TO RELATED APPLICATION(S)

This application claims priority to U.S. Application No. 63/562,324, filed Mar. 7, 2024, the content of which is incorporated herein by reference in its entirety.

### TECHNICAL FIELD

Various embodiments relate to atomic object confinement apparatuses and methods for fabricating surface electrodes of atomic object confinement apparatuses. For example, various embodiments relate to the use of damascene processes for fabricating surface electrodes of an atomic object confinement apparatus.

### BACKGROUND

Atomic object confinement apparatuses are used to confine or trap atomic objects, such as atoms, ions, molecules, and/or the like. For atomic object confinement apparatuses having surface electrodes, the topology of the surface of the electrodes can affect the electric field generated by the electrodes and can affect downstream processing steps of the atomic object confinement apparatus. Through applied effort, ingenuity, and innovation many deficiencies of such atomic object confinement apparatuses and methods of fabrication thereof have been solved by developing solutions that are structured in accordance with the embodiments of the present invention, many examples of which are described in detail herein.

### BRIEF SUMMARY OF EXAMPLE EMBODIMENTS

Example embodiments provide atomic object confinement apparatuses, systems comprising atomic object confinement apparatuses, and methods for fabricating atomic object confinement apparatuses. In various embodiments, an atomic object confinement apparatus comprises a plurality of surface electrodes. Application of voltage signals to the surface electrodes generates an electric potential near the surface of the atomic object confinement apparatus that is configured to confine and/or trap one or more atomic objects. In various embodiments, the surface electrodes are fabricated using a damascene process. In various embodiments, the atomic object confinement apparatus comprises a plurality of electrodes having planar surfaces after the electrode patterning fabrication step and have high-aspect ratio gaps between the electrodes in the finished atomic object confinement apparatus.

In an example embodiment, an atomic object confinement apparatus includes a substrate comprising a plurality of vias; a plurality of electrodes disposed on a surface of the substrate and in electric communication with respective vias of the plurality of vias; and a plurality of gaps. Respective gaps of the plurality of gaps are disposed between adjacent electrodes of the plurality of electrodes. Each gap of the plurality of gaps has a depth to width ratio of at least 0.9. For example, the depth to width ratio may be 1.1 or greater, in various embodiments.

In an example embodiment, a system including an atomic object confinement apparatus is provided. For example, the system may be a quantum charge-coupled device (QCCD)-based quantum computer that includes an atomic object confinement apparatus according to an example embodiment that is configured to confine a plurality of atomic objects that are used as qubits of the quantum computer.

In an example embodiment, a method for fabricating an atomic object confinement apparatus is provided. The method includes depositing an interlayer dielectric layer onto a surface of a substrate; patterning and etching the interlayer dielectric layer to form a segmented interlayer dielectric layer comprising a plurality of interlayer dielectric walls; depositing a bulk metal layer on the substrate and the segmented interlayer dielectric layer; and selectively etching away the plurality of interlayer dielectric walls to form a plurality of gaps and a plurality of electrodes. The exposed surfaces of the plurality of electrodes have root mean square (RMS) roughness of 10 nm or less (e.g., 5 nm or less, approximately 2 nm or less).

In various embodiments, respective gaps of the plurality of gaps are disposed between adjacent electrodes of the plurality of electrodes. Each gap of the plurality of gaps has a depth to width ratio of at least 0.9. For example, the depth to width ratio may be 1.1 or greater, in various embodiments.

According to one aspect, an atomic object confinement apparatus is provided. In an example embodiment, the atomic object confinement apparatus includes a substrate comprising a plurality of metal routing features (e.g., vias, through silicon vias (TSVs), interconnects, and/or the like); a plurality of electrodes disposed on a surface of the substrate and in electric communication with respective metal routing features of the plurality of metal routing features; and a plurality of gaps. Respective gaps of the plurality of gaps are disposed between adjacent electrodes of the plurality of electrodes. The respective exposed surfaces of the plurality of electrodes have RMS roughness of 10 nm or less.

In an example embodiment, each gap of the plurality of gaps has a depth to width ratio of at least 0.9.

In an example embodiment, respective exposed surfaces of the plurality of electrodes are coplanar.

In an example embodiment, the plurality of electrodes each comprise a bulk metal layer and a capping layer.

In an example embodiment, the atomic object confinement apparatus further includes at least one window post embedded within the bulk metal layer of an electrode of the plurality of electrodes, wherein the at least one window post comprises a material that is transparent for at least a selected range of frequencies of light.

In an example embodiment, capping layer is conductive and transparent for at least the selected range of frequencies of light.

In an example embodiment, the atomic object confinement apparatus further includes at least one window post embedded within an electrode of the plurality of electrodes, wherein the at least one window post is transparent for at least a selected range of frequencies of light; and a window cap at least partially aligned with the at least one window post, wherein the window cap is conductive and transparent for at least the selected range of frequencies of light.

In an example embodiment, the window cap is one of a raised window cap or a flush window cap.

In an example embodiment, the gap of the plurality of gaps comprises an undercut opening extending under a respective electrode of the plurality of electrodes.

In an example embodiment, the substrate further comprises a photonic layer disposed 0.5 to 20 μm below the plurality of electrodes.

According to another aspect, a method for fabricating an atomic object confinement apparatus is provided. In an example embodiment, the method includes depositing an interlayer dielectric layer onto a surface of a substrate; patterning and etching the interlayer dielectric layer to form a segmented interlayer dielectric layer comprising a plurality of interlayer dielectric walls; depositing a bulk metal layer on the substrate and the segmented interlayer dielectric layer; and selectively etching away the plurality of interlayer dielectric walls to form a plurality of gaps and a plurality of electrodes. Respective gaps of the plurality of gaps are disposed between adjacent electrodes of the plurality of electrodes. Respective exposed surfaces of the plurality of electrodes have root mean square (RMS) roughness of 10 nm or less.

In an example embodiment, each gap of the plurality of gaps has a depth to width ratio of at least 0.9.

In an example embodiment, the bulk metal layer is deposited with an overburden and the method further comprises, prior to selectively etching away the plurality of interlayer dielectric walls removing the overburden and planarizing a surface of the bulk metal layer, wherein the surface of the bulk metal layer is coplanar with respective end surfaces of the plurality of interlayer dielectric walls.

In an example embodiment, removing the overburden and planarizing the surface of the bulk metal layer is performed using chemical mechanical polishing.

In an example embodiment, the method further includes performing one or more additional patterning processes (e.g., lithographic or 3D printing by two-photon polymerization processes) after the planarizing of the surface of the bulk metal layer and before the selectively etching away of the plurality of interlayer dielectric walls.

In an example embodiment, the method further includes, prior to selectively etching away the plurality of interlayer dielectric walls, selectively etching the bulk metal layer so that a height of the bulk metal layer is smaller than a height of the plurality of interlayer dielectric walls; depositing a capping layer on the bulk metal layer and the plurality of interlayer dielectric walls; and planarizing a surface of the capping layer, wherein the surface of the capping layer is coplanar with respective end surfaces of the plurality of interlayer dielectric walls.

In an example embodiment, the method further includes performing one or more additional patterning processes (e.g., lithographic or 3D printing by two-photon polymerization processes) after the planarizing of the surface of the capping layer and before the selectively etching away of the plurality of interlayer dielectric walls.

In an example embodiment, the capping layer comprises at least one of niobium (Nb), indium tin oxide (ITO), aluminum zinc oxide (AZO), indium oxide (In₂O₃), titanium nitride (TiN), tantalum nitride (TaN), gold (Au), or platinum (Pt).

In an example embodiment, planarizing the surface of the capping layer is performed using at least one of chemical mechanical polishing or a patterned etch.

In an example embodiment, the bulk metal layer comprises at least one of copper (Cu), tungsten (W), or aluminum (Al).

In an example embodiment, the depth to width ratio is in a range of 1 to 5.

In an example embodiment, a width of the gap is in a range of 0.5 to 5 microns.

In an example embodiment, the segmented interlayer dielectric layer further comprises one or more window posts and the method further comprises, prior to the selectively etching away of the plurality of interlayer dielectric walls, depositing a capping layer on the bulk metal layer, the plurality of interlayer dielectric walls, and the one or more window posts, wherein the capping layer is conductive and transparent for at least a selected range of frequencies of light.

In an example embodiment, the substrate includes one or more photonics layers recessed a distance of 0.5 to 20 μm from the plurality of electrodes, the photonics layer comprising one or more photonic components in optical communication with the one or more window posts.

In an example embodiment, selectively etching away the plurality of interlayer dielectric walls to form a plurality of gaps further comprises etching away respective portions of the substrate to form respective undercut openings of the plurality of gaps.

In an example embodiment, the segmented interlayer dielectric layer comprises a window post and the method further comprises defining a window cap at least partially aligned with the window post, wherein the at least one window post is transparent for at least a selected range of frequencies of light, and wherein the window cap is conductive and transparent for at least the selected range of frequencies of light.

In an example embodiment, the window cap is one of a raised window cap or a flush window cap.

According to another aspect, a system comprising a confinement apparatus of an example embodiment is provided.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising an atomic object confinement apparatus, in accordance with an example embodiment.

FIG. 2 provides a top view of at least a portion of an example atomic object confinement apparatus, in accordance with an example embodiment.

FIG. 3 provides a flowchart illustrating various processes and/or procedures of fabricating an atomic object confinement apparatus, in accordance with an example embodiment.

FIGS. 4A-4K illustrate various steps of fabricating an atomic object confinement apparatus, in accordance with various embodiments.

FIG. 5 provides a flowchart illustrating various processes and/or procedures of fabricating an atomic object confinement apparatus including a transparent conductive window in an electrode, in accordance with various embodiments.

FIGS. 6A-6D illustrate various steps of fabricating an atomic object confinement apparatus including a transparent conductive window in an electrode, in accordance with an example embodiment.

FIGS. 7A-7E illustrate various steps of fabricating an atomic object confinement apparatus including a transparent conductive window in an electrode, in accordance with another example embodiment.

FIG. 8 provides a schematic diagram of an example controller of a system comprising a quantum object confinement apparatus configured for confining atomic objects therein, in accordance with an example embodiment.

FIG. 9 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, atomic objects are confined by an atomic object confinement apparatus (also referred to as a confinement apparatus herein). In various embodiments, an atomic object is an ion; atom; ionic, molecular, and/or multipolar molecule; quantum dot; quantum particle; group, crystal, and/or combination thereof (e.g., an ion crystal comprising two or more ions); and/or the like. In an example embodiment where the atomic objects are ions and/or ion crystals, the confinement apparatus is an ion trap, such as a surface ion trap, Paul ion trap, and/or the like. In various other embodiments, the confinement apparatus is an apparatus configured to confine atomic objects and comprises a plurality of surface electrodes. For example, in various embodiments, the confinement apparatus comprises a substrate that may include one or more layers including one or more vias, metal routing and/or interconnect layers, photonic/optical layers, and/or the like. A plurality of surface electrodes is formed on the substrate.

In various embodiments, the atomic objects confined by a confinement apparatus are used to perform experiments, controlled quantum state evolution, quantum computations, and/or the like. For example, the confinement apparatus may be part of an atomic system, such as an atomic clock, spectroscopic and/or mass analyzer system, quantum charge-coupled device (QCCD)-based quantum computer, and/or the like.

Conventional methods for forming surface electrodes of a confinement apparatus, such as metal lift off and direct metal etching tend to result in surface electrodes with significant surface topology. For example, the exposed surface of the surface electrodes formed through conventional surface electrode fabrication processes are not planar and/or smooth on a nanometer size scale. In the case of metal lift-off, there can be micron-scale topography from the thickness of the surface electrodes. In other cases, thin films of metals which are amenable to direct etch, for example aluminum, are also susceptible to forming roughness on the scale of hundreds of nanometers when the film is sufficiently thick (for example microns) to support the required current density of a charge trapping apparatus. In some instances, the topology of the exposed surface of the patterned surface electrodes is significant enough to affect the electrical potential generated by application of voltage signals to the surface electrodes of the confinement apparatus. In some instances, the topology of the exposed surface of the patterned surface electrodes is significant enough to affect downstream processes of fabricating the confinement apparatus, such as lithographic processes for fabricating load holes, performing die singulation, integrating photonics, and/or the like. This is particularly severe for metal lift-off, which produces micron-scale topography, which can exceed typical thickness of spin-on photo resist.

Moreover, the surface electrodes of a confinement apparatus need to be electrically insulated from one another to prevent crosstalk therebetween. However, conventional means for fabricating surface electrodes of a confinement apparatus tend to provide gaps between adjacent electrodes having depth to width ratios of less than 0.9. In some instances, a depth to width ratio of less than 0.9 does not provide sufficient electrical insulation between adjacent electrodes to prevent electrical shorting between the electrodes. Electrical shorting can result from metal line edge roughness, incomplete metal liftoff, or residues from the metal etch., technical challenges exist regarding the fabrication of surface electrodes of a confinement apparatus. These challenges are particularly severe when the depth to width ratios exceed 0.9.

Another challenge for the fabrication of an atomic confinement apparatus is the need to shield the confined atom from spurious electric fields which can interfere with the atomic system, for example by causing energy level shifts, displacements, heating, or even loss or de-confinement of the atomic object. One source of such electric fields is inadequate screening of trapped charges in the interlayer dielectric below the surface electrodes. A standard method of improving the electric field screening is to etch the interlayer dielectric below the bottom of the surface electrodes. However, there are various challenges to this method. For example, there may be poor chemical compatibility between the interlayer dielectric etch process and the electrode material, which limits surface electrode material choices. Other examples include controlling the depth and directionality of the etch. In contrast, surface electrode gaps having depth to width ratios exceeding 0.9 are effective at screening the atomic object from trapped charges in the interlayer dielectric (ILD) without requiring deep etching of the ILD.

Embodiments of the present disclosure provide technical solutions to these technical problems. Various embodiments provide confinement apparatuses, systems comprising confinement apparatuses, and/or methods for fabricating confinement apparatuses that provide gaps between adjacent electrodes that have depth to width ratios greater than 0.9 (e.g., greater than 1.0, greater than 1.1, greater than 1.5, in a range of 1.0 to 3, in a range of 1.0 to 5, in a range of 1.1 to 5, and/or the like). Various embodiments provide confinement apparatuses, systems comprising confinement apparatuses, and/or methods for fabricating confinement apparatuses that provide surface electrodes that have planar and/or smooth surfaces on the nanometer scale.

In various embodiments, the surface electrodes are formed using a damascene mask process. For example, interlayer dielectric walls are formed on a substrate. A bulk metal layer is deposited on the substrate and the interlayer dielectric walls and then planarized. The planarization may be performed by chemical mechanical polishing (CMP) or a patterned etch. This planarization causes the surface of the wafer to be planar and/or smooth on the nanometer scale such that downstream processes are simplified due to the lack of large topological features on the electrode surfaces. The interlayer dielectric walls are subsequently selectively etched to form gaps between adjacent electrodes. In various embodiments the gaps have depth to width ratios greater than 0.9 (e.g., greater than 1.0, greater than 1.1, greater than 1.5, in a range of 1.0 to 3, in a range of 1.0 to 5, in a range of 1.1 to 5, and/or the like).

Thus, various embodiments provide confinement apparatuses having surface electrodes that have exposed surfaces that are coplanar and/or smooth on a nanometer size scale and that have gaps between adjacent electrodes having depth to width ratios that are greater than 0.9. Various embodiments provide systems that include such confinement apparatuses and various embodiments provide methods for fabricating such confinement apparatuses. Various embodiments therefore provide an improvement to the field of confinement apparatuses, systems including confinement apparatuses, and methods for fabricating confinement apparatuses.

### Exemplary System Comprising an Atomic Object Confinement Apparatus

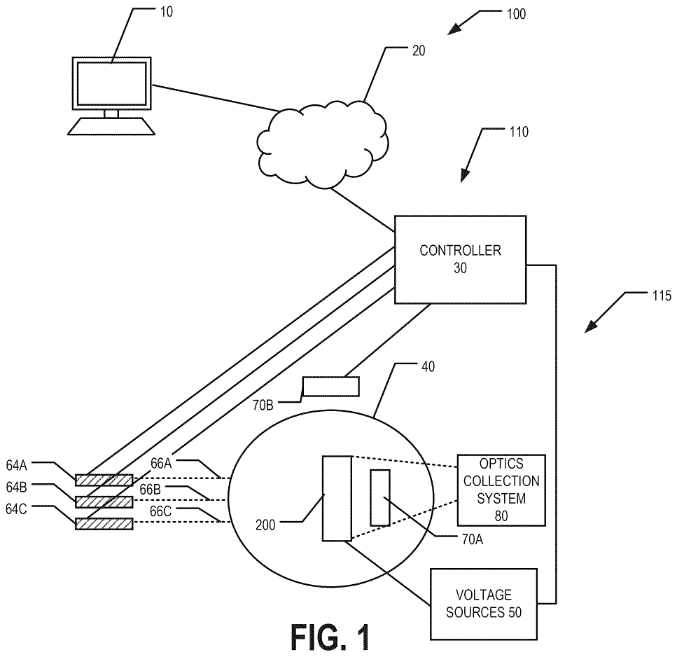

As noted above, various confinement apparatuses of various embodiments may be incorporated into various atomic systems, quantum systems, and/or the like. For example, various embodiments provide a system 100 comprising an atomic object confinement apparatus 200, as shown in FIG. 1. The atomic object confinement apparatus 200 is configured to confine a plurality of atomic objects such that the respective quantum states of the atomic objects may be manipulated, evolved in a controlled manner (e.g., in accordance with a quantum circuit), and/or the like.

For example, atomic objects may be used as the qubits of a quantum computer 110. For example, quantum operations (one qubit quantum logic gates, two qubit quantum logic gates, initialization, reading/detecting operations, and/or the like) may be performed on atomic objects confined by the confinement apparatus 200 and/or system 100 comprising the confinement apparatus. For example, the confinement apparatus 200 is configured to maintain one or more atomic objects at respective locations and/or transport atomic objects between respective locations such that the quantum operation may be performed on the one or more atomic objects.

In various embodiments, the system 100 comprising the confinement apparatus 200 comprises one or more manipulation sources 64 (e.g., 64A, 64B, 64C) configured to provide manipulation signals (e.g., laser beams and/or pulses, microwave signals/fields, and/or the like) such that the manipulation signals interact with one or more atomic objects confined at particular locations defined at least in part by the confinement apparatus. In various embodiments, the system 100 comprising the confinement apparatus 200 comprises one or more magnetic field sources 70 (e.g., 70A, 70B) configured to provide a controlled magnetic field and/or magnetic field gradient at particular locations defined at least in part by the confinement apparatus for use in performing one or more quantum operations on one or more atomic objects confined by the confinement apparatus 200. In various embodiments, the system 100 comprising the confinement apparatus 200 comprises an optics collection system configured to collect and/or detect light and/or photons emitted by one or more atomic objects disposed at the particular locations defined at least in part by the confinement apparatus.

In an example embodiment, the system 100 comprising the confinement apparatus 200 is and/or includes a quantum charge-coupled device (QCCD)-based quantum computer 110. For example, one or more of the atomic objects confined by the confinement apparatus 200 may be used as qubits of the quantum computer 110.

In various embodiments, the system 100 comprises a classical and/or semiconductor-based computing entity 10 and a quantum computer 110. In various embodiments, the quantum computer 110 comprises a controller 30 and a quantum processor 115. In various embodiments, the quantum processor 115 comprises a cryostat and/or vacuum chamber 40 enclosing a confinement apparatus 200, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic objects confined by the confinement apparatus 200. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/detection, and/or like) on atomic objects confined by the confinement apparatus.

In an example embodiment, the one or more manipulation sources 64 each provide a manipulation signal (e.g., laser beam and/or the like) to one or more regions of the atomic object confinement apparatus 200 via corresponding beam path systems 66 (e.g., 66A, 66B, 66C). In various embodiments, at least one beam path system 66 comprises a modulator configured to modulate the manipulation signal being provided to the confinement apparatus 200 via the beam path system 66. In various embodiments, a beam path system 66 includes one or more photonic elements (e.g., waveguides, beam splitters, grating couplers, modulators, polarizers, etc.) integrated on the same substrate as the confinement apparatus and/or a photonic integrated circuit (PIC) disposed within the cryostat and/or vacuum chamber 40. In an example embodiment, a beam path system 66 includes one or more optical fibers configured to transport manipulation signals at least partially from a manipulation source 64 to a PIC formed on the same substrate as the confinement apparatus and/or another substrate configured to be secured with respect to the confinement apparatus (e.g., packaged with the substrate housing the confinement apparatus). In an example embodiment, one or more of the manipulation sources 64 are disposed within the cryostat and/or vacuum chamber 40 (e.g., on the same substrate as the confinement apparatus and/or another substrate configured to be secured with respect to the confinement apparatus). In various embodiments, the manipulation sources 64, modulator, and/or other components of the quantum computer 110 are controlled by the controller 30.

In various embodiments, the confinement apparatus 200 is an ion trap, such as a surface ion trap, Paul ion trap, and/or the like. In various embodiments, the atomic objects are ions; atoms; ion crystals and/or groups; atomic crystals and/or groups; charged, neutral, and/or multipolar molecules; quantum dots; quantum particles; groups, crystals, and/or combinations thereof (e.g., ion crystals); and/or the like. In various embodiments, the confinement apparatus 200 is an appropriate confinement apparatus for confining the atomic objects of the embodiment.

In various embodiments, the quantum computer 110 comprises one or more voltage sources 50. For example, the voltage sources may be arbitrary wave generators (AWG), digital to analog converters (DACs), and/or other voltage signal generators. For example, the voltage sources 50 may comprise a plurality of longitudinal voltage drivers and/or voltage sources and/or at least one RF driver and/or voltage source. The voltage sources 50 may be electrically coupled to the corresponding potential generating elements and/or surface electrodes (e.g., control electrodes and/or RF electrodes) of the confinement apparatus 200, in an example embodiment.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more regions of the confinement apparatus 200 that has a particular magnitude and a particular magnetic field direction in the one or more regions of the confinement apparatus 200.

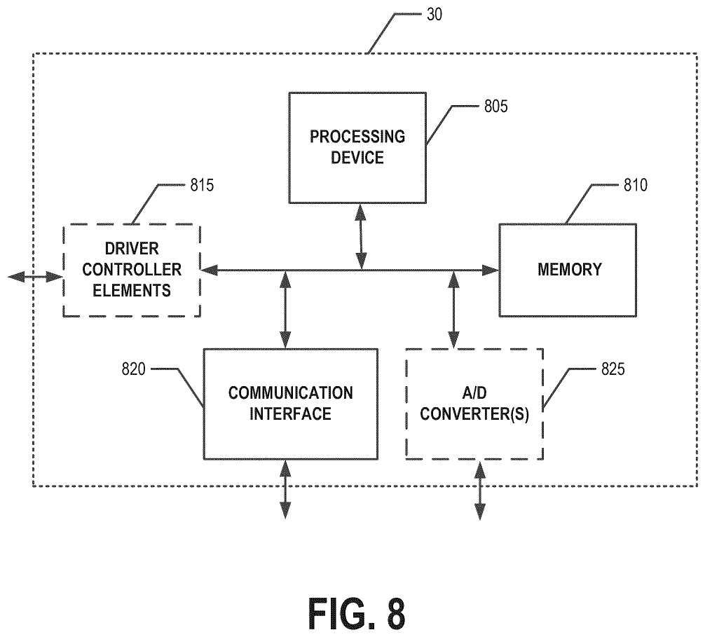

In various embodiments, the quantum computer 110 comprises an optics collection system 80 configured to collect and/or detect photons (e.g., stimulated emission) generated by atomic objects disposed in respective locations (e.g., during reading/detection operations) defined at least in part by the confinement apparatus. The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic objects. While the optics collection system 80 is illustrated as being outside of the cryostat and/or vacuum chamber 40, in various embodiments, one or more optical elements and/or the one or more photodetectors of the optics collection system may be disposed within the cryostat and/or vacuum chamber 40. In various embodiments, the detectors may be in electronic communication with the controller 30 via one or more A/D converters 825 (see FIG. 8) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more atomic objects within the confinement apparatus, and/or read and/or detect a quantum (e.g., qubit) state of one or more atomic objects within the confinement apparatus 200. For example, the controller 30 may cause a controlled evolution of quantum states of one or more atomic objects within the confinement apparatus to execute a quantum circuit and/or algorithm. For example, the controller 30 may read and/or detect quantum states of one or more atomic objects within the confinement apparatus at one or more points during the execution of a quantum circuit. In various embodiments, the atomic objects confined by the confinement apparatus are used as qubits of the quantum computer 110.

### Example Atomic Object Confinement Apparatus

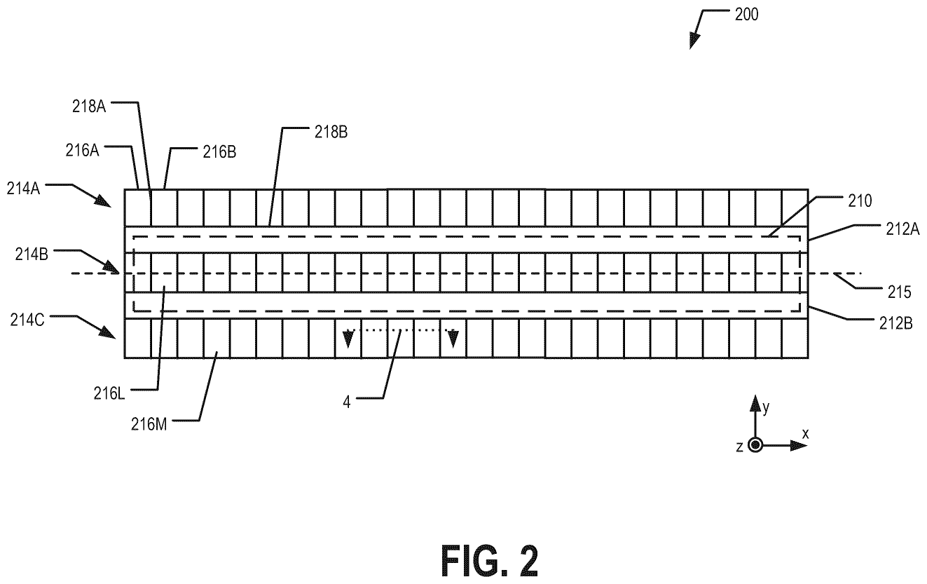

FIG. 2 provides a top view of at least a portion of an example confinement apparatus 200 that may be used to confine one or more atomic objects. For example, in the illustrated embodiment, the confinement apparatus is an ion trap (e.g., a surface ion trap) and the atomic objects are ions and/or ion crystals. The linear portion of the example confinement apparatus 200 may be part of a larger linear geometry of the confinement apparatus or may be part of a two-dimensional or three-dimensional geometry of the confinement apparatus, in various embodiments.

In an example embodiment, the confinement apparatus 200 (e.g., surface ion trap) is fabricated as part of an ion trap chip and/or part of an ion trap apparatus and/or package. In an example embodiment, the confinement apparatus 200 is at least partially defined by a number of RF electrodes 212 (e.g., 212A, 212B). While the RF electrodes 212 are illustrated as generally rectangular, in various embodiments, the RF electrodes 212 may have various geometries, as appropriate for the application. In various embodiments, the confinement apparatus 200 is at least partially defined by a number of sequences of control electrodes 214 (e.g., 214A, 214B, 214C). Each sequence of control electrodes 214 comprises a plurality of control electrodes 216 (e.g., 216A, 216B, . . . , 216L, 216M). While the control electrodes 216 are illustrated as generally rectangular, in various embodiments, the control electrodes 216 may have various geometries, as appropriate for the application.

In an example embodiment, each control electrode 216 and/or at least a non-empty subset of the control electrodes 216 may be operated independently via the application of control signals thereto. In an example embodiment, at least some of the control electrodes 216 are operated via application of a broadcast control signal. In an example embodiment, the confinement apparatus 200 is a surface Paul trap with symmetric RF electrodes 212. In various embodiments, the RF electrodes 212 and the control electrodes 216 generate potentials and/or fields that are experienced by atomic objects within respective confinement regions of the confinement apparatus 200. In particular, the RF electrodes 212 may be configured to define the respective confinement regions 210 of the confinement apparatus 200 and the control electrodes 216 may be configured to at least partially control movement and/or motion of atomic objects within the respective confinement regions.

A gap 218A is disposed between adjacent control electrodes 216. For example, control electrodes 216A, 216B are adjacent electrodes as the control electrodes 216A, 216B are separated only by the gap 218A (e.g., there are no other electrodes between the adjacent control electrodes 216A, 216B). In various embodiments, a control electrode 216 and an adjacent RF electrode 212 are separated by a gap 218B. In various embodiments, the gap 218 (e.g., 218A, 218b) has a depth d to width w ratio of at least 0.9. In various embodiments, the depth d to width w ratio of the gap 218 is greater than 1.1, greater than 1.5, in a range of 1.0 to 3, in a range of 1.0 to 5, in a range of 1.1 to 5, and/or the like.

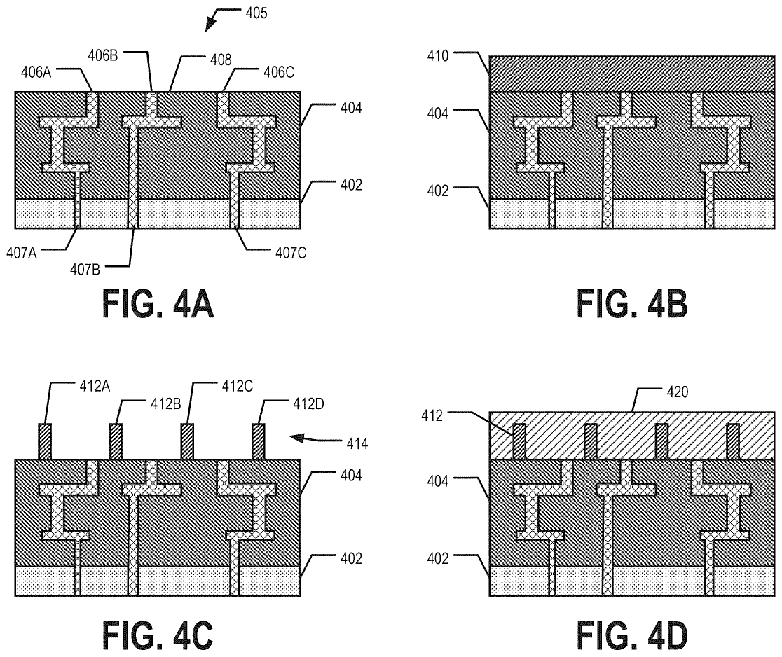

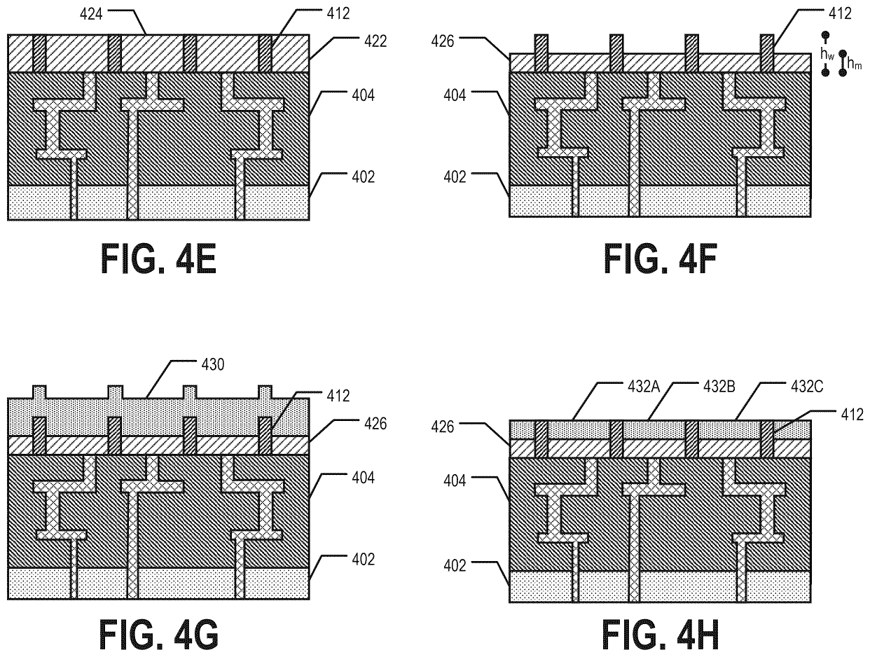

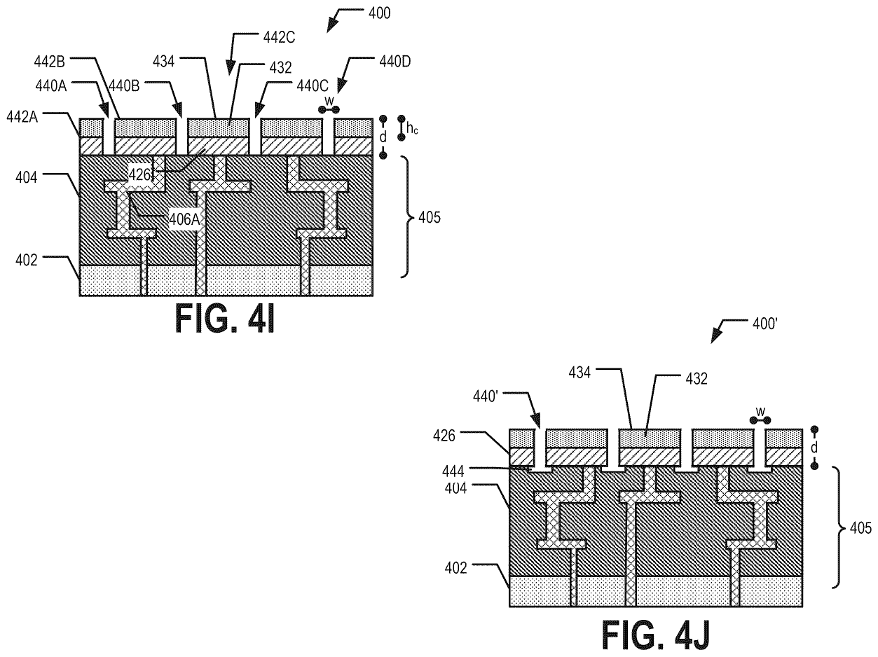

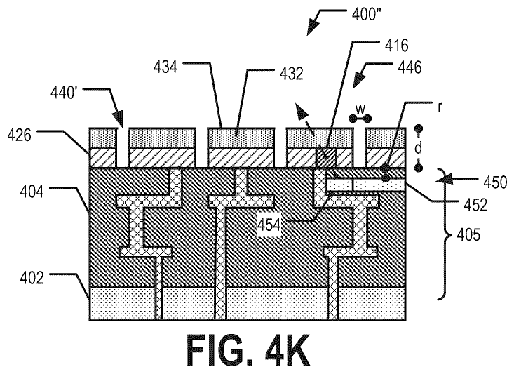

FIGS. 4I, 4J, and 4K illustrate cross-sectional views of portions of some example embodiments of an atomic object confinement apparatus 400, 400′, 400″. For example, FIG. 4I is a cross section taken at line 4 in FIG. 2. In various embodiments, a confinement apparatus 400, 400′ includes a substrate 405 and a plurality of electrodes 442 (e.g., 442A, 442B, 442C) formed on the substrate 405. For example, the electrodes 442 may include the control electrodes 216 and/or the RF electrodes 212. The substrate 405 comprises a plurality of vias 406 (e.g., 406A, 406B, 406C), as shown in FIG. 4A. In an example embodiment, the vias 406 are in electrical communication with respective through silicon vias (TSVs) 407 (e.g., 407A, 407B, 407C) for providing electrical signals (e.g., voltage signals) to the respective electrodes. For example, the substrate 405 may include a variety of interconnect layers, vias, metal routing, integrated photonics layers (see FIG. 4K), and/or the like. Adjacent electrodes of the plurality of surface electrodes 442 are separated from one another by gaps 440 (e.g., 440A, 440B, 440C, 440D).

In various embodiments, the electrodes each include a single layer of bulk metal material. In various embodiments, the electrodes 442 include a recessed segment 426 formed of a bulk metal material and a capping segment 432 formed of capping material. The exposed surfaces 434 are smooth, planar surfaces. For example, the exposed surface 434 is considered smooth because the exposed surface 434 has an RMS (root mean square) roughness of no larger than 10 nm. In an example embodiment, the exposed surface 424 have an RMS roughness of less than 5 nm (e.g., 2 nm or less).

For example, the exposed surface 434 are smooth and/or planar on at least a nanometer size scale. In various embodiments, the exposed surfaces 434 of the electrodes define a plane that is parallel to a plane formed by the surface of the substrate 405.

In an example embodiment illustrated in FIG. 4J, the confinement apparatus 400′ includes gaps 440′ that include an undercut opening 444. For example, in some embodiments, the gaps 440′ extend under the electrodes 442.

In an example embodiment illustrated in FIG. 4K, the confinement apparatus 400″ includes one or more integrated photonics layers 450 that each include one or more respective photonic elements. For example, the illustrated integrated photonics layer 450 includes photonic components such as a waveguide 452 and a coupler 454. For example, in various embodiments, one or more electrodes 442 include respective windows 446. In various embodiments, the coupler 454 is aligned with the window 446 such that the coupler 454 couples light out of the waveguide 452 and out through the window 446, as shown by the dashed arrow. In an example embodiment, the coupler 454 is configured to couple light that passed through the window 446 into the waveguide 452. For example, a dielectric window post 416 may extend through the bulk metal material (e.g., through a recessed segment 426) of a segmented electrode 442 to allow light to pass therethrough. In an example embodiment, the capping segment 432 includes a capping material that is conductive and transparent for at least a selected range of frequencies of light.

In various embodiments, the waveguide 452, and the photonic layer 450 of the substrate 405 that includes the waveguide 452, is recessed a distance r below the electrodes 442. For example, in various embodiments, the distance r is measured between a surface of the waveguide 452 that is closest to the electrodes and a surface of the electrodes 442 that is closest to the waveguide 452. In an example embodiment, the distance r is in a range of 0.5 to 20 μm. In an example embodiment, the distance r is in a range of 1 to 3 μm (e.g., 2.0+/−0.05 μm). At least one photonic component (e.g., the waveguide 452, the coupler 454, and/or the like) of the photonic layer 450 is in optical communication with the window post 416. In various embodiments, photonics layers 450 may be disposed directly beneath the plurality of electrodes. In various embodiments, one or more layers of the substrate 405 are disposed between the photonics layer(s) 450 and the plurality of electrodes.

### Example Method of Fabricating a Confinement Apparatus

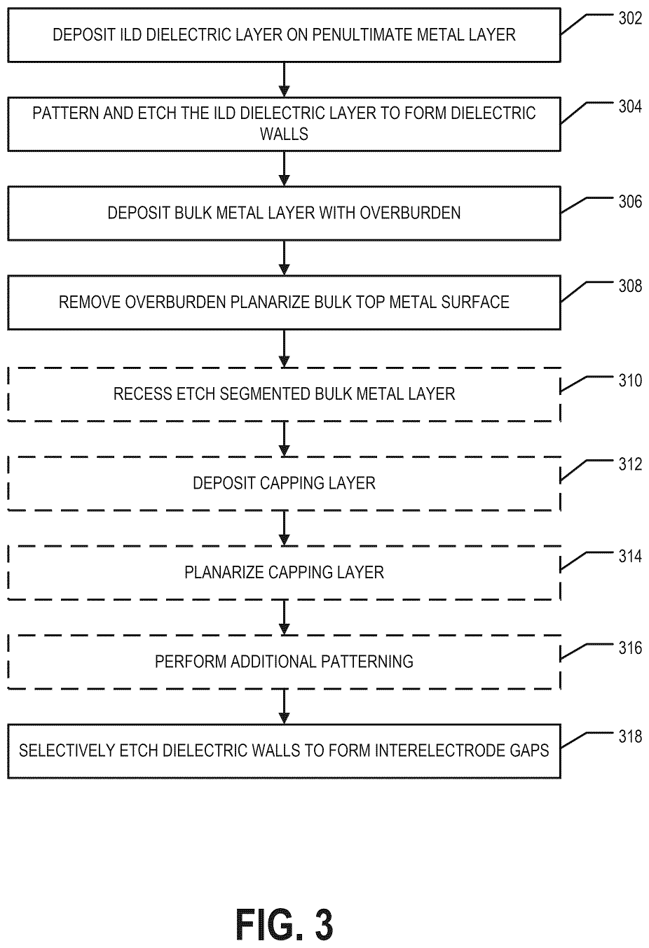

FIG. 3 provides a flowchart illustrating various processes, procedures, operations, and/or the like for fabricating a confinement apparatus 400. FIGS. 4A-4I illustrate cross-sectional views of various steps of fabricating a confinement apparatus 400. FIG. 4J illustrates a cross-sectional view of an alternative embodiment of a confinement apparatus 400′. FIG. 4K illustrates a cross-section view of an alternative embodiment of a confinement apparatus 400″, which is an example of a confinement apparatus that includes a conductive transparent window in at least one electrode.

In various embodiments, the confinement apparatus 400 is formed on a substrate 405, as shown in FIG. 4A. The substrate 405 comprises a plurality of vias 406 (e.g., 406A, 406B, 406C), interconnects, TSVs 407, and/or other metal routing features. In various embodiments, the vias, interconnects, TSVs, and/or other metal routing features are configured to provide voltage and/or current signals to the electrodes 442 when the confinement apparatus 400 is operated. In various embodiments, the substrate 405 includes a variety of interconnect layers, vias, TSVs, integrated photonic layers, and/or other metal routing features. For example, the illustrated substrate 405 includes a wafer portion 402 and an interconnect layer 404 including the plurality of vias 406, interconnects, and/or other metal routing features.

At step 302, an interlayer dielectric (ILD) layer 410 is deposited on the penultimate metal interconnect layer 408, as shown in FIG. 4B. For example, the ILD layer 410 is deposited using a chemical vapor deposition (CVD) process in an example embodiment. In an example embodiment, the material of the ILD layer 410 is selected to have a low dielectric constant and low dielectric loss at radio frequencies. For example, in various embodiments, the ILD layer 410 comprises SiO₂. In some embodiments, the ILD layer 410 is deposited using CVD with silane or tetraethyl low-k dielectric materials, such as F-doped SiO₂, C-doped SiO₂, orthosilicate glass, fluorosilicate glass, and/or the like.

In an example embodiment, the ILD layer 410 is deposited to at least a depth d, which is the intended depth of the gaps 440. In an example embodiment, the depth d of the ILD layer 410 is larger or smaller than the intended depth of the gaps 440. In various embodiments, the ILD layer 410 is deposited to a depth d that is equal to or greater than the intended thickness of the electrodes (including any capping layer).

At step 304, the ILD layer 410 is patterned and etched to form a segmented dielectric layer 414 that includes a plurality of dielectric walls 412 (e.g., 412A, 412B, 412C, 412D), as shown in FIG. 4C. In various embodiments, the ILD layer 410 is patterned and etched to form the segmented dielectric layer 414 using lithography, masked etching, and/or similar processes. For example, the ILD layer 410 may be etched using dry etching or wet etching for form the segmented dielectric layer 414.

In an example embodiment, the segmented dielectric layer 414 includes one or more window posts 416. For example, a window post 416 may be patterned out of the ILD layer 410.

As shown in FIG. 4D, at step 306, at bulk metal layer 420 is deposited on the substrate 405 and the segmented dielectric layer 414. In various embodiments, the bulk metal layer 420 is deposited using a CVD process, a physical vapor deposition (PVD) process (e.g., sputtering), an electro-plating deposition process, an electroless plating deposition process, and/or the like. In some embodiments, multiple deposition processes may be used to deposit the bulk metal layer 420. For example, in an example embodiment, a PVD process may be used to start the deposition of the bulk metal layer 420 and the deposition of the bulk metal layer 420 may be finished using an electroplating deposition process. In various embodiments, the bulk metal layer 420 is deposited using a conformal deposition.

In various embodiments, the bulk metal layer 420 comprises a conductive, low resistivity metal. In various embodiments, the bulk metal layer 420 comprises a material that may be processed and/or planarized via chemical mechanical processing (CMP). For example, in various embodiments, the bulk metal layer 420 comprises a bulk metal material. In various embodiments, the bulk metal material comprises one or more of copper (Cu), tungsten (W), or aluminum (Al).

In various embodiments, the bulk metal layer 420 is deposited with an overburden. For example, the bulk metal layer 420 is deposited to a depth that is greater than the height of the dielectric walls 412. For example, the bulk metal layer 420 is deposited with an overburden such that there are no holes or empty spaces within the bulk metal layer 420 and/or at the interfaces between the dielectric walls 412 and/or window posts 416 with the bulk metal layer 420.

At step 308, the overburden is removed from the bulk metal layer 420 to provide a segmented bulk metal layer 422, as shown in FIG. 4E. Moreover, at step 308, the exposed surface of the segmented bulk metal layer 422 is planarized. For example, the overburden may be removed to provide the exposed surface 424 via CMP. For example, the segmented bulk metal layer 422 comprises a plurality of segments of bulk metal material that are separated and/or defined by the dielectric walls 412. Additionally, the CMP planarizes the exposed surface 424 such that the exposed surface 424 of the segmented bulk metal layer 422 is planar and/or smooth. For example, any topological features of the exposed surface 424 are less than twenty nanometer in size. For example, the exposed surface 424 have has an RMS roughness of no larger than 10 nm. In an example embodiment, the exposed surface 424 have an RMS roughness of less than 5 nm (e.g., 2 nm or less).

In an example embodiment, at least a portion of the overburden is removed using a dry, wet, and/or patterned etch and any remainder of the overburden is removed via a CMP. The CMP planarizes and/or smooths the exposed surface 424 of the segmented bulk metal layer 422.

In various embodiments, the electrodes consist of the bulk metal material. In such embodiments, the fabrication process does not include steps 310-314. In various embodiments, the electrodes include a capping material in addition to the bulk metal material. In such embodiments, the process continues to step 310.

At step 310, the segments of the segmented bulk metal layer 422 are recess etched to form the recessed segments 426 of the bulk metal material, as shown in FIG. 4F. For example, the segments of the segmented bulk metal layer 422 may be wet etched to form the recessed segments 426. In an example embodiment, the dielectric walls 412 have a wall height h_{w}. For example, the dielectric walls 412 extend a wall height h_{w} from the surface of the penultimate metal layer 408 of the substrate 405. In an example embodiment, the recessed segments 426 of the bulk metal material have a metal height hₘ. For example, the recessed segments 426 of the bulk metal material extend a metal height hₘ from the surface of the penultimate metal layer 408 of the substrate 405. The recess etching causes the metal height hₘ to be less than the wall height h_{w}. In an example embodiment, the wall height h_{w} is in a range of 50 to 500 nm larger than the metal height hₘ. In an example embodiment, the wall height h_{w} is in a range of 100 nm to 5 μm. In various embodiments, the recess etching is performed using a selective etching process configured to etch the bulk metal material and to not etch the dielectric material of the dielectric walls 412.

At step 312, a capping layer 430 is conformally deposited on the recessed segments 426 of the bulk metal material and the dielectric walls 412, as shown in FIG. 4G. In various embodiments, the capping layer 430 comprises a caping material that is conductive. In an example embodiment, the capping material is a material the does not from resistive oxides under normal environmental conditions and/or under vacuum and/or cryogenic conditions. For example, in an example embodiment, the capping material comprises one or more of niobium (Nb), indium tin oxide (ITO), aluminum zinc oxide (AZO), indium oxide (In₂O₃), titanium nitride (TiN), tantalum nitride (TaN), gold (Au), or platinum (Pt). In an example embodiment, the capping material is transparent for at least a selected range of frequencies of light. In various embodiments, the capping layer 430 is deposited using a CVD process, a PVD process, atomic layer deposition (ALD), and/or the like.

At step 314, the capping layer is planarized. For example, any overburden of the capping layer 430 is removed such that capping segments 432 (e.g., 432A, 432B, 432C) are formed as shown in FIG. 4H. The capping segments 432 are each formed on and in electrical communication with a respective recessed segment 426 of bulk metal material. The capping segments 432 and their respective recessed segments 426 form the electrodes 442. The recessed segments 426 are separated and/or isolated from the neighboring recessed segments by the dielectric walls 412.

In various embodiments, planarizing the capping layer includes performance of CMP. In an example embodiment, planarizing the capping layer includes performing a patterned etching. For example, performing the patterned etching may include determining a profile and/or topology of the surfaces of the capping segments 432 and then performing an etching to smooth and/or flatten the surfaces of the capping segments. For example, the etching may be performed to remove and/or reduce in size any topological features of the surfaces of the capping segments 432 that are larger than 20 nm in size. For example, the etching and/or polishing may be performed to smooth any topological features of the surfaces of the capping segments 432 such that surfaces of the capping segments have an RMS roughness of no larger than 10 nm. In an example embodiment, the surfaces of the capping segments 432 have an RMS roughness of less than 5 nm (e.g., 2 nm or less).

For example, the patterned etching may be performed using reactive ion etching (RIE), and/or other targeted etching process or etching process that can be controlled as a function of location.

In various embodiments, the capping segments 432 having a capping height h_{c} for example, the capping segments 432 may extend a capping height h_{c} from the recessed segments 426. In an example embodiment, the capping height h_{c} is in a range of 10 to 200 nm. In an example embodiment, the capping height h_{c} is approximately 100 nm.

At step 316, any additional patterning of the confinement apparatus 400 is performed. For example, lithographic patterning may be performed to form and/or the like one or more features of the confinement apparatus 400. For example, a load hole may be etched through at least a portion of the confinement apparatus 400. For example, lithographic processing may be used to perform die singulation and one or more processes related to integrated photonics of the confinement apparatus 400. In various embodiments, various processes in addition to or alternative to lithography may be used to perform additional patterning of the confinement apparatus 400. For example, three-dimensional (3D) printing by two-photon polymerization may be used to perform additional patterning of the confinement apparatus 400 after formation of the plurality of electrodes 442.

In various embodiments, the planar nature of the surfaces 434 of the electrodes 442 allows the additional patterning and/or lithographic processing of the confinement apparatus 400 to be performed more easily, more accurately, and/or the like. For example, two-photon polymerization includes dispensing photoresists liquid onto the wafer surface, followed by near infrared (NIR) exposure and develop. It is difficult to clean out and/or remove un-exposed resist from pre-existing topographical features. Photolithography faces similar challenges when pre-existing topological features are present. By smoothing the surfaces 434 of the electrodes 442 to having an RMS roughness no larger than 10 nm (e.g., less than 5 nm, approximately 2 nm or less) these provides technical solutions to such technical fabrication challenges.

At step 318, a selective etching is performed to remove the dielectric walls 412 and form the gaps 440. For example, an etching process is performed that is configured to etch away the dielectric material of the dielectric walls 412 and to not etch the capping material of the capping segments 432 or the bulk metal material of the recessed segments 426. In various embodiments, a dry etching process and/or reactive ion etching (RIE) is used to selectively remove the dielectric walls 412. For example, the selective etching is performed to form gaps 440 having a depth d and a width w. In various embodiments, the depth d of the gaps 440 is in a range of 100 nm to 5.5 μm. In various embodiments, the width w of the gaps 440 is such that the depth d to width w ratio is at least 0.9. In various embodiments, the depth d to width w ratio is greater than 1.0, greater than 1.1, greater than 1.5, in a range of 1.0 to 3, in a range of 1.0 to 5, in a range of 1.1 to 5, and/or the like.

In an example embodiment, step 318 may further include the application of a patterned photoresist and/or other resist layer to the capping segments 432 and/or the segmented bulk metal layer 422 prior to the selective etching to remove the dielectric walls 412. For example, the photoresist and/or other resist layer may protect the electrode surface to minimize and/or reduce damage to the electrode surface during the selective etching. The photoresist and/or other resist layer may then be removed after the dielectric walls 412 have been removed.

In an example embodiment, the selective etching of the dielectric walls 412 includes etching undercut openings 444 such that the gaps 440′ extend under the electrodes 442.

In various embodiments, fabricating the confinement apparatus 400 may include depositing one or more barrier layers, seed layers, adhesion layers and/or the like (e.g., on the surface of the substrate 405 and/or on the surface of the recessed segments 426, as appropriate for the materials of the substrate 405, the dielectric material of the ILD layer 410, the bulk metal material of the bulk metal layer 420, and/or the capping material of the capping layer 430. For example, in various embodiments, such barrier layers, seed layers, and/or adhesion layers may include TiN, tantalum (Ta), TaN, and/or the like. In various embodiments, such barrier layers, seed layers, and/or adhesion layers may be deposited to a thickness of 0.5 to 50 nm.

### Example Methods of Fabricating a Confinement Apparatus Including Conductive Transparent Windows in Electrodes

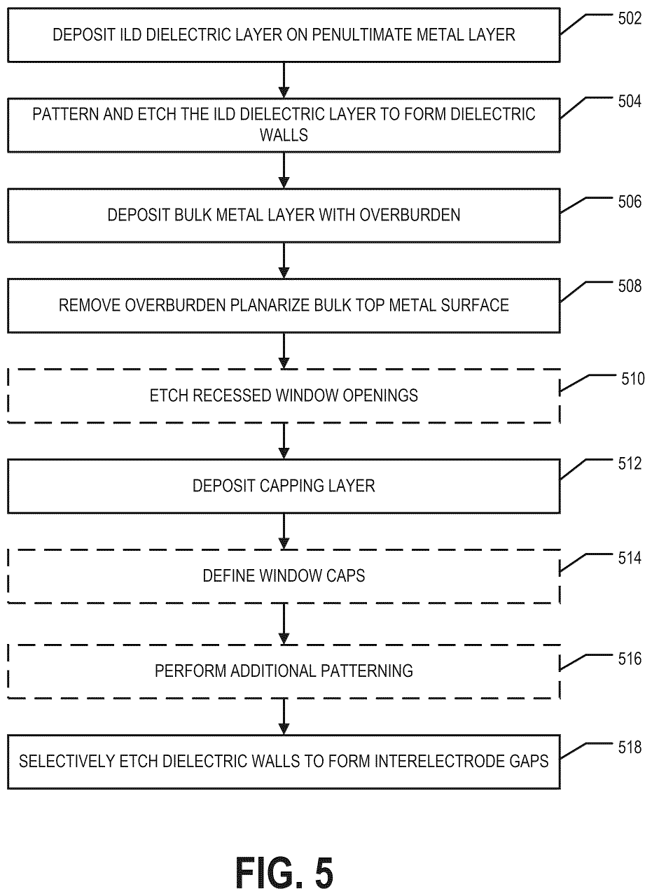

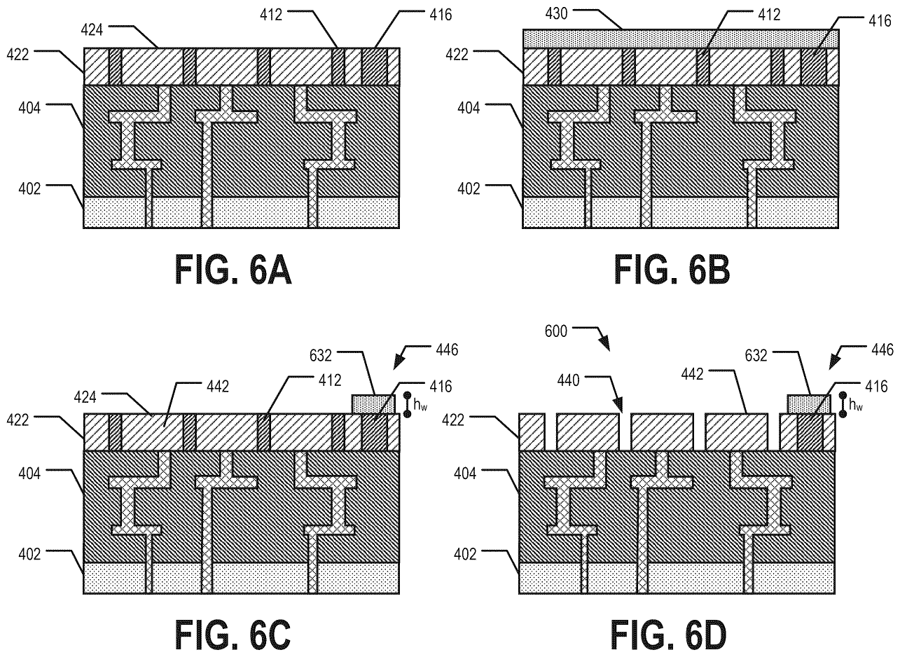

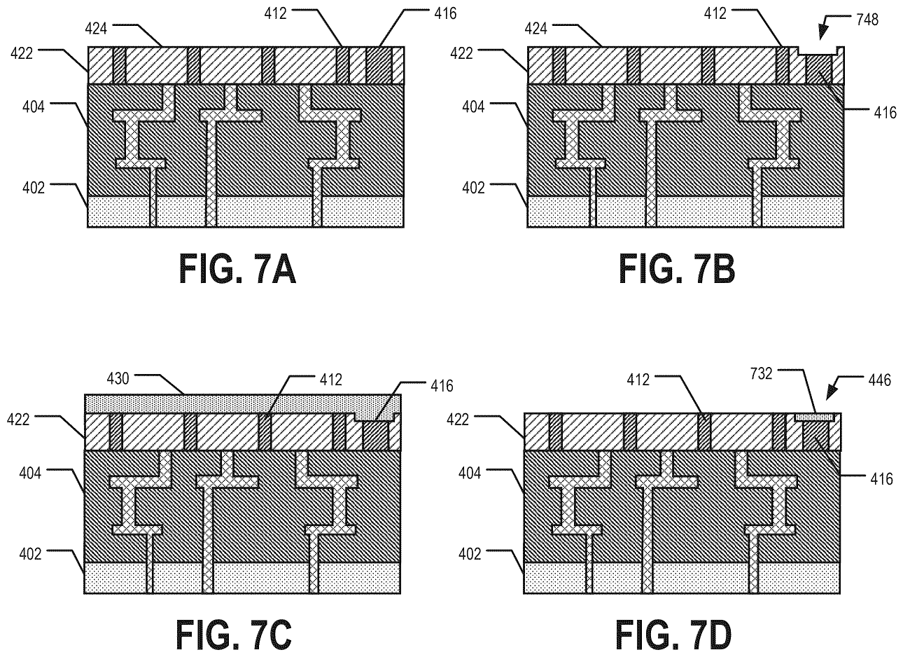

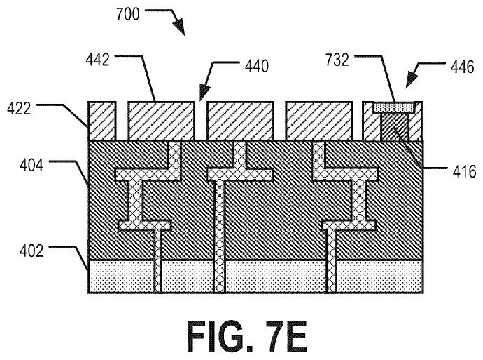

FIG. 5 provides a flowchart illustrating various processes, procedures, operations, and/or the like for fabricating a confinement apparatus 600, 700 (see FIGS. 6D and 7E) that includes a conductive transparent window in at least one electrode and that does not include a capping layer on all of the electrodes. FIGS. 6A-6D illustrate cross-sectional views of various steps of fabricating a confinement apparatus 600 that includes at least one raised transparent conductive window in an electrode. FIGS. 7A-7E illustrates a cross-sectional view of an alternative embodiment of a confinement apparatus 700 that includes at least one flush transparent conductive window in an electrode.

In various embodiments, the confinement apparatus 400 is formed on a substrate 405, similar to that shown in FIG. 4A. The substrate 405 comprises a plurality of vias 406 (e.g., 406A, 406B, 406C), interconnects, TSVs 407, and/or other metal routing features. In various embodiments, the vias, interconnects, TSVs, and/or other metal routing features are configured to provide voltage and/or current signals to the electrodes 442 when the confinement apparatus 600, 700 is operated. In various embodiments, the substrate 405 includes a variety of interconnect layers, vias, TSVs, integrated photonic layers, and/or other metal routing features. For example, the illustrated substrate 405 includes a wafer portion 402 and an interconnect layer 404 including the plurality of vias 406, interconnects, and/or other metal routing features.

At step 502, an interlayer dielectric (ILD) layer 410 is deposited on the penultimate metal interconnect layer 408, similar to that shown in FIG. 4B. For example, the ILD layer 410 is deposited using a chemical vapor deposition (CVD) process in an example embodiment. In an example embodiment, the material of the ILD layer 410 is selected to have a low dielectric constant and low dielectric loss at radio frequencies. For example, in various embodiments, the ILD layer 410 comprises SiO₂. In some embodiments, the ILD layer 410 is deposited using CVD with silane or tetraethyl low-k dielectric materials, such as F-doped SiO₂, C-doped SiO₂, orthosilicate glass, fluorosilicate glass, and/or the like.

In an example embodiment, the ILD layer 410 is deposited to at least a depth d, which is the intended depth of the gaps 440. In an example embodiment, the depth d of the ILD layer 410 is larger or smaller than the intended depth of the gaps 440. In various embodiments, the ILD layer 410 is deposited to a depth d that is equal to or greater than the intended thickness of the electrodes (including any capping layer).

At step 504, the ILD layer 410 is patterned and etched to form a segmented dielectric layer 414 that includes a plurality of dielectric walls 412 (e.g., 412A, 412B, 412C, 412D) and one or more window posts 416. In various embodiments, the ILD layer 410 is patterned and etched to form the segmented dielectric layer 414 using lithography, masked etching, and/or similar processes. For example, the ILD layer 410 may be etched using dry etching or wet etching for form the segmented dielectric layer 414.

Similar to as shown in FIG. 4D, at step 506, at bulk metal layer 420 is deposited on the substrate 405 and the segmented dielectric layer 414. In various embodiments, the bulk metal layer 420 is deposited using a CVD process and/or a PVD process (e.g., sputtering), an electro-plating deposition process, an electroless plating deposition process, and/or the like. In some embodiments, multiple deposition processes may be used to deposit the bulk metal layer 420. For example, in an example embodiment, a PVD process may be used to start the deposition of the bulk metal layer 420 and the deposition of the bulk metal layer 420 may be finished using an electroplating deposition process. In various embodiments, the bulk metal layer 420 is deposited using a conformal deposition.

In various embodiments, the bulk metal layer 420 comprises a conductive, low resistivity metal. In various embodiments, the bulk metal layer 420 comprises a material that may be processed and/or planarized via chemical mechanical processing (CMP). For example, in various embodiments, the bulk metal layer 420 comprises a bulk metal material. In various embodiments, the bulk metal material comprises one or more of Cu, W, or Al.

In various embodiments, the bulk metal layer 420 is deposited with an overburden. For example, the bulk metal layer 420 is deposited to a depth that is greater than the height of the dielectric walls 412. For example, the bulk metal layer 420 is deposited with an overburden such that there are no holes or empty spaces within the bulk metal layer 420 and/or at the interfaces between the dielectric walls 412 and/or window posts 416 with the bulk metal layer 420.

At step 508, the overburden is removed from the bulk metal layer 420 to provide a segmented bulk metal layer 422, as shown in FIGS. 6A and 7A. Moreover, at step 508, the exposed surface of the segmented bulk metal layer 422 is planarized. For example, the overburden may be removed to provide the exposed surface 424 via CMP. For example, the segmented bulk metal layer 422 comprises a plurality of segments of bulk metal material that are separated and/or defined by the dielectric walls 412. Additionally, the CMP planarizes the exposed surface 424 such that the exposed surface 424 of the segmented bulk metal layer 422 is planar and/or smooth. For example, any topological features of the exposed surface 424 are less than twenty nanometer in size. For example, the exposed surface 424 have has an RMS roughness of no larger than 10 nm. In an example embodiment, the exposed surface 424 have an RMS roughness of less than 5 nm (e.g., 2 nm or less).

In an example embodiment, at least a portion of the overburden is removed using a dry, wet, and/or patterned etch and any remainder of the overburden is removed via a CMP. The CMP planarizes and/or smooths the exposed surface 424 of the segmented bulk metal layer 422.

At step 510, in an example embodiment, one or more recessed window openings are etched in respective electrodes 442, as shown in FIG. 7B. For example, one or more segments of the segmented bulk metal layer 422 may be wet etched to form the recessed window openings 748. For example, the segmented bulk metal layer 422 may be patterned (e.g., using lithographic and/or masked etching processes, for example) to include one or more recessed window openings 748 in respective electrodes 442. In an example embodiment, a recessed window opening 748 extends 5 to 30 nm into the electrode 442. In various embodiments, the recessed window opening 748 is centered on and/or at least partially aligned with a window post 416 disposed within the corresponding electrode 442.

At step 512, a capping layer 430 is conformally deposited on the segmented bulk metal layer 422 and the dielectric walls 412 (and within any recessed window openings 748 that present). For example, FIGS. 6B and 7C illustrate the capping layer 430 deposited on the segmented bulk metal layer 422 and the dielectric walls 412 (and within any recessed window openings 748 that present). In various embodiments, the capping layer 430 comprises a caping material that is conductive and transparent for at least a selected range of frequencies of light. In an example embodiment, the capping material is a material the does not from resistive oxides under normal environmental conditions and/or under vacuum and/or cryogenic conditions. For example, in an example embodiment, the capping material comprises one or more of niobium (Nb), indium tin oxide (ITO), aluminum zinc oxide (AZO), indium oxide (In₂O₃), titanium nitride (TiN), tantalum nitride (TaN), gold (Au), or platinum (Pt). In various embodiments, the capping layer 430 is deposited using a CVD process, a PVD process, atomic layer deposition (ALD), and/or other conformal deposition process.

At step 514, the window caps 632, 732 are defined, as shown in FIGS. 6C and 7D. For example, for a confinement apparatus 600 having a raised transparent conductive window 446 in an electrode 442, the capping layer 430 is patterned to form the raised window cap 632. For example, a patterned etch may be performed to form the raised window cap 632. A raised window cap 632 is raised and/or extends outward from a surface 424 of the segmented bulk metal layer 422 and/or the corresponding electrode 442. In an example embodiment, the raised window cap 632 extends a window height h_{w} from the surface 424 of the electrode 424. In various embodiments, the window height h_{w} is in a range of 5 to 30 nm.

In another example, for a confinement apparatus 700 having a flush transparent conductive window 446 in an electrode 442, the surface of the confinement apparatus is etched and/or polished (e.g., via CMP) to provide a planarized and/or smooth exposed surfaces 424 of the electrodes 442 and to form the flush window cap 732. For example, a flush transparent conductive window 446 is recessed into the electrode 442 such that the surface 424 of the electrode 442 is smooth. For example, the surface of the bulk metal material of the electrode 442 and the surface of the recessed window cap 732 are smooth, continuous, flush, and/or planar with respect to one another.

In various embodiments, any portion of the capping layer 430 that is not forming a window cap 632, 732 is removed from the surface 424 of the electrodes 442. In various embodiments, the window caps 632, 732 are each at least partially aligned with a respective window post 416.

For example, the etching and/or polishing may be performed to remove and/or reduce in size any topological features of the surfaces of the capping segments 432 that are larger than 20-30 nm in size. For example, for embodiments including flush window caps 732, the surfaces 424 of the electrodes 442 have an RMS roughness of no larger than 10 nm. In an example embodiment, the surfaces 424 of the electrodes 442 have an RMS roughness of less than 5 nm (e.g., 2 nm or less).

At step 516, any additional patterning of the confinement apparatus 600, 700 is performed. For example, lithographic patterning may be performed to form and/or the like one or more features of the confinement apparatus 600, 700. For example, a load hole may be etched through at least a portion of the confinement apparatus 600, 700. For example, lithographic processing may be used to perform die singulation and one or more processes related to integrated photonics of the confinement apparatus 600, 700. In various embodiments, various processes in addition to or alternative to lithography may be used to perform additional patterning of the confinement apparatus 600, 700. For example, three-dimensional (3D) printing by two-photon polymerization may be used to perform additional patterning of the confinement apparatus 600, 700 after formation of the plurality of electrodes 442.

In various embodiments, the planar nature of the surfaces 424 of the electrodes 442 allows the additional patterning and/or lithographic processing of the confinement apparatus 600, 700 to be performed more easily, more accurately, and/or the like. For example, two-photon polymerization includes dispensing photoresists liquid onto the wafer surface, followed by near infrared (NIR) exposure and develop. It is difficult to clean out and/or remove un-exposed resist from pre-existing topographical features. Photolithography faces similar challenges when pre-existing topological features are present. By smoothing the surfaces 424 of the electrodes 442 to having an RMS roughness no larger than 10 nm (e.g., less than 5 nm, approximately 2 nm or less) these provides technical solutions to such technical fabrication challenges.

At step 518, a selective etching is performed to remove the dielectric walls 412 and form the gaps 440. For example, an etching process is performed that is configured to etch away the dielectric material of the dielectric walls 412 and to not etch the capping material of the window caps 632, 732 or the bulk metal material of the electrodes 442. In various embodiments, a dry etching process and/or reactive ion etching (RIE) is used to selectively remove the dielectric walls 412. For example, the selective etching is performed to form gaps 440 having a depth d and a width w. In various embodiments, the depth d of the gaps 440 is in a range of 100 nm to 5.5 μm. In various embodiments, the width w of the gaps 440 is such that the depth d to width w ratio is at least 0.9. In various embodiments, the depth d to width w ratio is greater than 1.0, greater than 1.1, greater than 1.5, in a range of 1.0 to 3, in a range of 1.0 to 5, in a range of 1.1 to 5, and/or the like.

In an example embodiment, step 518 may further include the application of a patterned photoresist and/or other resist layer to the window caps 632, 732 and/or the surfaces 424 of the segmented bulk metal layer 422 prior to the selective etching to remove the dielectric walls 412. For example, the photoresist and/or other resist layer may protect the electrode surface and/or window caps to minimize and/or reduce damage to the electrode surface and/or window caps during the selective etching. The photoresist and/or other resist layer may then be removed after the dielectric walls 412 have been removed.

In an example embodiment, the selective etching of the dielectric walls 412 includes etching undercut openings such that the gaps extend under the electrodes 442.

### Technical Advantages

Conventional methods for forming surface electrodes of a confinement apparatus, such as metal lift off and direct metal etching tend to result in surface electrodes with significant surface topology. For example, the exposed surface of the surface electrodes formed through conventional surface electrode fabrication processes are not planar and/or smooth on a nanometer size scale. In the case of metal lift-off, there can be micron-scale topography from the thickness of the surface electrodes. In other cases, thin films of metals which are amenable to direct etch, for example aluminum, are also susceptible to forming roughness on the scale of hundreds of nanometers when the film is sufficiently thick (for example microns) to support the required current density of a charge trapping apparatus. In some instances, the topology of the exposed surface of the patterned surface electrodes is significant enough to affect the electrical potential generated by application of voltage signals to the surface electrodes of the confinement apparatus. In some instances, the topology of the exposed surface of the patterned surface electrodes is significant enough to affect downstream processes of fabricating the confinement apparatus, such as lithographic processes for fabricating load holes, performing die singulation, integrating photonics, and/or the like. This is particularly severe for metal lift-off, which produces micron-scale topography, which can exceed typical thickness of spin-on photo resist.

Moreover, the surface electrodes of a confinement apparatus need to be electrically insulated from one another to prevent crosstalk therebetween. However, conventional means for fabricating surface electrodes of a confinement apparatus tend to provide gaps between adjacent electrodes having depth to width ratios of less than 0.9. In some instances, a depth to width ratio of less than 0.9 does not provide sufficient electrical insulation between adjacent electrodes to prevent electrical shorting between the electrodes. Electrical shorting can result from metal line edge roughness, incomplete metal liftoff, or residues from the metal etch., technical challenges exist regarding the fabrication of surface electrodes of a confinement apparatus. These challenges are particularly severe when the depth to width ratios exceed 0.9.

Another challenge for the fabrication of an atomic confinement apparatus is the need to shield the confined atom from spurious electric fields which can interfere with the atomic system, for example by causing energy level shifts, displacements, heating, or even loss or de-confinement of the atomic object. One source of such electric fields is inadequate screening of trapped charges in the interlayer dielectric below the surface electrodes. A standard method of improving the electric field screening is to etch the interlayer dielectric below the bottom of the surface electrodes. However, there are various challenges to this method. For example, there may be poor chemical compatibility between the interlayer dielectric etch process and the electrode material, which limits surface electrode material choices. Other examples include controlling the depth and directionality of the etch. In contrast, surface electrode gaps having depth to width ratios exceeding 0.9 are effective at screening the atomic object from trapped charges in the interlayer dielectric (ILD) without requiring deep etching of the ILD.

Embodiments of the present disclosure provide technical solutions to these technical problems. Various embodiments provide confinement apparatuses, systems comprising confinement apparatuses, and/or methods for fabricating confinement apparatuses that provide gaps between adjacent electrodes that have depth to width ratios greater than 0.9 (e.g., greater than 1.0, greater than 1.1, greater than 1.5, in a range of 1.0 to 3, in a range of 1.0 to 5, in a range of 1.1 to 5, and/or the like). Various embodiments provide confinement apparatuses, systems comprising confinement apparatuses, and/or methods for fabricating confinement apparatuses that provide surface electrodes that have planar and/or smooth surfaces on the nanometer scale such that downstream process are simplified due to the lack of large topological features on the electrode surfaces.

In various embodiments, the surface electrodes are formed using a damascene mask process. For example, interlayer dielectric walls are formed on a substrate. A bulk metal layer is deposited on the substrate and the interlayer dielectric walls and then planarized. The planarization may be performed by chemical mechanical polishing (CMP) or a patterned etch. This planarization causes the surface of the electrodes to be planar and/or smooth on the nanometer scale. The interlayer dielectric walls are selectively etched to form gaps between adjacent electrodes. In various embodiments the gaps have depth to width ratios greater than 0.9 (e.g., greater than 1.0, greater than 1.1, greater than 1.5, in a range of 1.0 to 3, in a range of 1.0 to 5, in a range of 1.1 to 5, and/or the like).

The high depth-to-width ratio helps to screen the confined atomic objects from trapped charges in the dielectric (e.g., disposed beneath and/or between the electrodes) which would otherwise contribute to heating, displacement, de-confinement, or atomic energy level shifting of the confined atomic objects. This reduces the need for deep etch or undercut of the ILD below the bottom surface of the electrodes, which are challenging processes to integrate. Nonetheless, deep/undercut ILD etching can be used in combination with the methods of this invention for further benefit. The improvements provided by the high depth-to-width ratio enable dimensional scaling of the confinement apparatus to allow higher numbers of trapped atomic objects (i.e., higher qubit count in quantum computers). Dimensional scaling includes shrinking of lateral electrode dimensions and/or reduction of the height of the confined atomic objects above the electrode surface.

Thus, various embodiments provide confinement apparatuses having surface electrodes that have exposed surfaces that are coplanar and/or smooth on a nanometer size scale (e.g., RMS roughness of 10 nm or less) and/or that have gaps between adjacent electrodes having depth to width ratios that are greater than 0.9. These improvements, beyond addressing technical challenges described above, enable dimensional scaling of confinement apparatus to allow higher numbers of trapped atomic objects (i.e., higher qubit count in quantum computers). Dimensional scaling includes shrinking of control electrode dimensions and/or reduction of the height of the confined atomic objects above the electrode surface.

Various embodiments therefore provide an improvement to the field of confinement apparatuses, systems including confinement apparatuses, and methods for fabricating confinement apparatuses.

### Example Controller

Various embodiments provide systems comprising confinement apparatuses 400, 400′, 400″, 600, 700. For example, various atomic systems, quantum systems, and/or the like may use a confinement apparatus 400, 400′, 400″, 600, 700 to confine one or more atomic objects. In an example embodiment, the system is a quantum charge-coupled device (QCCD-based) quantum computer 110 or other quantum computer. In various embodiments, the system (e.g., quantum computer 110) includes a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more atomic objects confined by the confinement apparatus, and/or read and/or detect a quantum state of one or more atomic objects confined by the confinement apparatus.

As shown in FIG. 8, in various embodiments, the controller 30 may comprise various controller elements including one or more processing devices 805, memory 810, driver controller elements 815, a communication interface 820, analog-digital converter elements 825, and/or the like. For example, the one or more processing devices 805 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 805 of the controller 30 comprises a clock and/or is in communication with a clock. In various embodiments, this clock defines the clock cycles of the system.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 810 (e.g., by a processing device 805) causes the controller 30 to perform one or more steps, operations, processes, procedures and/or the like described herein for controlling one or more components of the quantum computer 110 (e.g., voltages sources 50, manipulation sources 64, magnetic field sources 70, and/or the like) to cause a controlled evolution of quantum states of one or more atomic objects, detect and/or read the quantum state of one or more atomic objects, and/or the like.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 805). In various embodiments, the driver controller elements 815 may enable the controller 30 to operate a manipulation source 64. In various embodiments, the drivers may be laser drivers; vacuum component drivers; drivers for controlling the flow of current and/or voltage applied to the electrodes (e.g., the RF, control, and/or other electrodes of the confinement apparatus 400, 400′, 400″, 600, 700) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the electrodes 442 (e.g., control electrodes 216 and/or RF electrodes 212). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 825 configured to receive signals from one or more detectors, optical receiver components, calibration sensors, and/or the like.

In various embodiments, the controller 30 may comprise a communication interface 820 for interfacing and/or communicating with one or more computing entities 10. For example, the controller 30 may comprise a communication interface 820 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Example Computing Entity

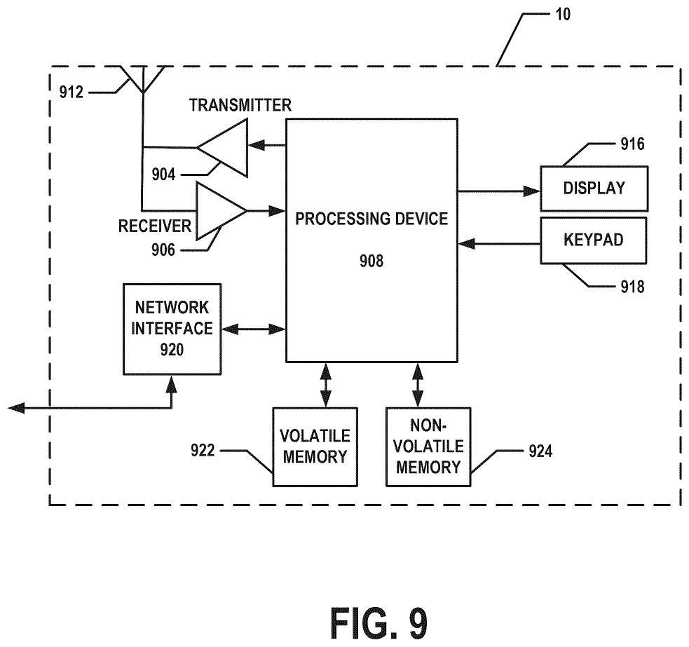

FIG. 9 provides an illustrative schematic representative of an example computing entity 10 that can be used in conjunction with embodiments of the present invention.

In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 9, a computing entity 10 can include an antenna 912, a transmitter 904 (e.g., radio), a receiver 906 (e.g., radio), and a processing device 908 that provides signals to and receives signals from the transmitter 904 and receiver 906, respectively.

The signals provided to and received from the transmitter 904 and the receiver 906, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 920 configured to communicate via one or more wired and/or wireless networks 20.

The computing entity 10 may also comprise a user interface device comprising one or more user input/output interfaces (e.g., a display 916 and/or speaker/speaker driver coupled to a processing device 908 and a touch screen, keyboard, mouse, and/or microphone coupled to a processing device 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An atomic object confinement apparatus comprising:
a substrate comprising a plurality of metal routing features;
a plurality of electrodes disposed on a surface of the substrate and in electric communication with respective metal routing features of the plurality of metal routing features; and
a plurality of gaps, respective gaps of the plurality of gaps disposed between adjacent electrodes of the plurality of electrodes,
wherein respective exposed surfaces of the plurality of electrodes have root mean square (RMS) roughness of 10 nm or less.

2. The atomic object confinement apparatus of claim 1, wherein each gap of the plurality of gaps has a depth to width ratio of at least 0.9.

3. The atomic object confinement apparatus of claim 1, wherein the plurality of electrodes each comprise a bulk metal layer and a capping layer.

4. The atomic object confinement apparatus of claim 3, further comprising at least one window post embedded within the bulk metal layer of an electrode of the plurality of electrodes, wherein the at least one window post comprises a material that is transparent for at least a selected range of frequencies of light and that is electrically conductive.

5. The atomic object confinement apparatus of claim 1, further comprising:
at least one window post embedded within an electrode of the plurality of electrodes, wherein the at least one window post is transparent for at least a selected range of frequencies of light; and
a window cap at least partially aligned with the at least one window post, wherein the window cap is conductive and transparent for at least the selected range of frequencies of light, and the window cap is one of a raised window cap, a recessed window cap, or a flush window cap.

6. The atomic object confinement apparatus of claim 1, wherein the gap of the plurality of gaps comprises an undercut opening extending under a respective electrode of the plurality of electrodes.

7. The atomic object confinement apparatus of claim 1, wherein the substrate further comprises one or more photonics layers disposed 0.5 to 20 μm below the plurality of electrodes.

8. A method for fabricating an atomic object confinement apparatus, the method comprising:
depositing an interlayer dielectric layer onto a surface of a substrate;
patterning and etching the interlayer dielectric layer to form a segmented interlayer dielectric layer comprising a plurality of interlayer dielectric walls;
depositing a bulk metal layer on the substrate and the segmented interlayer dielectric layer; and
selectively etching away the plurality of interlayer dielectric walls to form a plurality of gaps and a plurality of electrodes, wherein respective gaps of the plurality of gaps are disposed between adjacent electrodes of the plurality of electrodes,
wherein respective exposed surfaces of the plurality of electrodes have root mean square (RMS) roughness of 10 nm or less.

9. The method of claim 8, wherein each gap of the plurality of gaps is etched to have a depth to width ratio of at least 0.9.

10. The method of claim 8, wherein the bulk metal layer is deposited with an overburden and the method further comprises, prior to selectively etching away the plurality of interlayer dielectric walls:
removing the overburden and planarizing a surface of the bulk metal layer, wherein the surface of the bulk metal layer is coplanar with respective end surfaces of the plurality of interlayer dielectric walls.

11. The method of claim 10, wherein removing the overburden and planarizing the surface of the bulk metal layer is performed using chemical mechanical polishing.

12. The method of claim 10, further comprising performing one or more additional patterning processes after the planarizing of the surface of the bulk metal layer and before the selectively etching away of the plurality of interlayer dielectric walls.

13. The method of claim 8, further comprising, prior to selectively etching away the plurality of interlayer dielectric walls:
selectively etching the bulk metal layer so that a height of the bulk metal layer is smaller than a height of the plurality of interlayer dielectric walls;
depositing a capping layer on the bulk metal layer and the plurality of interlayer dielectric walls; and
planarizing a surface of the capping layer, wherein the surface of the capping layer is coplanar with respective end surfaces of the plurality of interlayer dielectric walls.

14. The method of claim 13, further comprising performing one or more additional patterning processes after the planarizing of the surface of the capping layer and before the selectively etching away of the plurality of interlayer dielectric walls.

15. The method of claim 13, wherein the capping layer comprises at least one of niobium (Nb), indium tin oxide (ITO), aluminum zinc oxide (AZO), indium oxide (In₂O₃), titanium nitride (TiN), tantalum nitride (TaN), gold (Au), or platinum (Pt).

16. The method of claim 13, wherein planarizing the surface of the capping layer is performed using at least one of chemical mechanical polishing or a patterned etch.

17. The method of claim 8, wherein at least one of:
the bulk metal layer comprises at least one of copper (Cu), tungsten (W), or aluminum (Al),
a depth-to-width ratio of the plurality of gaps is in a range of 1 to 5, or
a width of the gap is in a range of 0.5 to 5 microns.

18. The method of claim 8, wherein the segmented interlayer dielectric layer further comprises one or more window posts and the method further comprises, prior to the selectively etching away of the plurality of interlayer dielectric walls, depositing a capping layer on the bulk metal layer, the plurality of interlayer dielectric walls, and the one or more window posts, wherein the capping layer is conductive and transparent for at least a selected range of frequencies of light, wherein the substrate includes one or more photonics layers recessed a distance of 0.5 to 20 μm from the plurality of electrodes, at least one of the one or more photonics layers comprising one or more photonic components in optical communication with at least one of the one or more window posts.

19. The method of claim 8, wherein selectively etching away the plurality of interlayer dielectric walls to form a plurality of gaps further comprises etching away respective portions of the substrate to form respective undercut openings of the plurality of gaps.

20. The method of claim 8, wherein the segmented interlayer dielectric layer comprises a window post and the method further comprises defining a window cap at least partially aligned with the window post, wherein the at least one window post is transparent for at least a selected range of frequencies of light, and wherein the window cap is conductive and transparent for at least the selected range of frequencies of light and wherein the window cap is one of a raised window cap, a recessed window cap, or a flush window cap.
